(19) United States
(12) Patent Application Publication
(10) Pub. No.: US 2026/0141491 A1
(43) Pub. Date: May 21, 2026

(54) VIDEO PROCESSING METHOD AND APPARATUS, DEVICE AND MEDIUM

(71) Applicant: Beijing Zitiao Network Technology Co., Ltd., Haidian District, Beijing (CN)

(72) Inventor: Lushuang CHEN, Beijing (CN)

(21) Appl. No.: 19/117,349

(22) PCT Filed: Nov. 23, 2023
(86) PCT No.: PCT/CN2023/133612

§ 371 Date: Mar. 31, 2025

(30) Foreign Application Priority Data
Nov. 23, 2022 (CN) 202211475553.3

(51) Int. Cl. G06T 5/70; G06T 3/40; G06T 5/50; G06T 7/207; G06T 13/80

(52) U.S. Cl. CPC G06T 5/70; G06T 3/40; G06T 5/50; G06T 7/207; G06T 13/80; G06T 2207/10016; G06T 2207/20016; G06T 2207/20201; G06T 2207/20221

(57) ABSTRACT

The embodiment of the present disclosure is provided with a video processing method and apparatus, a device and a medium, wherein the method includes: in response to receiving a motion blur request for a target video, obtaining motion blur information set; performing inter-frame motion estimation on a target frame image in the target video and an associated frame image of the target frame image according to the motion blur information and obtaining a motion trend between the target frame image and the associated frame image; wherein the target frame image is an image to be blurred; performing blur processing on the target frame image based on the associated frame image and the motion trend and obtaining a blur frame image corresponding to the target frame image; and generating a motion blur video corresponding to the target video based on the blur frame image.

### CROSS-REFERENCE TO RELATED APPLICATIONS

The present disclosure claims priority to CN Patent Application No. 202211475553.3 titled “VIDEO PROCESSING METHOD AND APPARATUS, DEVICE AND MEDIUM” filed on Nov. 23, 2022, the disclosure of which is incorporated by reference herein in its entirety.

### TECHNICAL FIELD

The present disclosure relates to the field of video processing technology, in particular to a video processing method and apparatus, device and medium.

### BACKGROUND

With promoted editing needs of a user, the functions of a video editing software are gradually diversified. Some video editing software begins to provide a special effect of motion blur, which creates a dynamic and atmospheric sense of feint flow by motion blur, thereby enhancing the expressiveness of a video.

### SUMMARY

The present disclosure provides a video processing method and apparatus, a device and a medium.

In a first aspect, the embodiment of the present disclosure provides a video processing method, including: in response to receiving a motion blur request for a target video, obtaining motion blur information set by the user; wherein the motion blur information indicates a blur processing manner; performing inter-frame motion estimation on a target frame image in the target video and an associated frame image of the target frame image according to the motion blur information and obtaining a motion trend between the target frame image and the associated frame image; wherein the target frame image is an image to be blurred; performing blur processing on the target frame image based on the associated frame image and the motion trend and obtaining a blur frame image corresponding to the target frame image; and generating a motion blur video corresponding to the target video based on the blur frame image.

In a second aspect, the embodiment of the present disclosure provides a video processing apparatus, including: a parameter obtaining module configured to obtain motion blur information set by a user in response to receiving a motion blur request for a target video; wherein the motion blur information indicates a blur processing manner; a motion estimating module configured to perform inter-frame motion estimation on a target frame image in the target video and an associated frame image of the target frame image according to the motion blur direction to obtain a motion trend between the target frame image and the associated frame image; wherein the target frame image is an image to be blurred; a blur processing module configured to performing blur processing on the target frame image based on the associated frame image and the motion trend and obtaining a blur frame image corresponding to the target frame image; and a video generating module configured to generate a motion blur video corresponding to the target video based on the blur frame image.

In a third aspect, the embodiment of the present disclosure also provides an electronic device, including: a processor; a memory for storing executable instructions by the processor; and the processor is configured to read the executable instructions from the memory and execute the executable instructions to implement the video processing method provided according to the embodiments of the present disclosure.

In a fourth aspect, the embodiment of the present disclosure also provides a non-transitory computer-readable storage medium having a computer program stored thereon for performing the video processing method provided according to the embodiments of the present disclosure.

In a fifth aspect, the embodiment of the present disclosure also provides a computer program, wherein the computer program when executed by a processor, implements the video processing method provided according to the embodiments of the present disclosure.

It should be understood that, the content described in this part is not intended to identify key or important features of the embodiments of the present disclosure, nor is it intended to limit the scope of the present disclosure. Other features of the present disclosure will become readily understood from the following specification.

### BRIEF DESCRIPTION OF THE DRAWINGS

The accompanying drawings herein, which are incorporated into the specification and constitute part of this specification, illustrate the embodiments conforming to the present disclosure and serve to explain the principles of the present disclosure together with the specification.

In order to explain the technical solution in the embodiments of the present disclosure or in the related art more explicitly, the accompanying drawings required to be used in the description of the embodiments or the related art will be briefly introduced below. Obviously, for those of ordinary skill in the art, other accompanying drawings may also be obtained according to these accompanying drawings on the premise that no inventive effort is involved.

FIG. 1 is a flowchart of a video processing method provided by embodiments of the present disclosure;

FIG. 2 is a schematic view of a motion blur direction provided by embodiments of the present disclosure;

FIG. 3 is a flowchart of a motion blur method provided by embodiments of the present disclosure;

FIG. 4 is a flowchart of another motion blur method provided by embodiments of the present disclosure;

FIG. 5 is a schematic view of input frames and output frames of a video provided by embodiments of the present disclosure;

FIG. 6 is a schematic structural view of a video processing apparatus provided by embodiments of the present disclosure;

FIG. 7 is a schematic structural view of an electronic device provided by embodiments of the present disclosure.

### DETAILED DESCRIPTION

In order to understand the above-described objects, features and advantages of the present disclosure more explicitly, the solution of the present disclosure will be further described below. It is to be noted that, the embodiments of the present disclosure and the features in the embodiments may be combined with each other without conflict.

In the following description, many specific details will be elaborated in order to adequately understand the present disclosure. However, the present disclosure may also be implemented in other methods than that described here. Apparently, the embodiments in the specification are only some of the embodiments of the present disclosure, rather than all of the embodiments.

The inventors have found through studies that, the special effect of motion blur provided by the existing software presents a single form of expression with a poor motion blur effect, so that it is probably difficult to satisfy users.

According to the technical solution provided by the embodiments of the present disclosure, it is possible to obtain a motion trend between the target frame image to be blurred and the associated frame image in the target video based on the motion blur information set by a user, perform blur processing on the target frame image based on the associated frame image and the motion trend, and further generate a motion blur video based on the blur frame image corresponding to the target frame image. The above-described method is helpful to make the motion blur video achieve a more authentic and coherent motion blur effect. Instead of performing motion blur processing by using fixed parameters, the target video is blurred based on the motion blur information set by a user, so that the user may personalize the motion blur information according to own needs. Different motion blur information may form a plurality of blur effects with abundant forms of expression, thereby making the finally obtained motion blur video more conform to the needs of the user.

The inventors have found through studies that, the special effect of motion blur provided by the existing software is mainly realized by the following two manners: 1) fixed parameters such as motion direction and blur intensity are preset, and preset parameters are used for motion blur processing regardless of the type of a video, which pertains to a static blur processing manner; 2) the motion blur rendering direction is determined based on the motion direction of the shot subject, and the motion blur rendering intensity is matched based on the motion speed of the shot subject, so as to bring a motion blur effect to the video. For the first manner, the obtained motion blur video presents a single form of expression with a poor effect, so that it is difficult to satisfy the needs of the user. For the second manner, although improved as compared with the first method, it is possible to determine the blur rendering direction based on the subject motion blur direction in the original video to be blurred, and to determine the blur rendering intensity according to the subject motion speed. However, for an original video, the obtained motion blur effect is also fixed, and there is still the problem of a single form of expression, and the blur rendering direction and the blur rendering intensity determined according to the original video might not be needed by the user, so that it is also difficult to favorably satisfy the needs of the user.

The above-described defects present in the motion blur solution in the related art are the results obtained by the applicant through practice and careful studies. Therefore, the process of finding the above-described defects and the solutions provided by the embodiment of the present application for the above-described defects in the following should be regarded as the applicant's contribution to the present application.

In order to improve the above issues, the embodiment of the present disclosure provides a video processing method and apparatus, a device and a medium, which will be described in detail below.

FIG. 1 is a flowchart of a video processing method provided by embodiments of the present disclosure, which may be performed by a video processing apparatus, wherein the device may be implemented by software and/or hardware, and generally may be incorporated into the electronic device. As shown in FIG. 1, the method mainly includes the following steps S102 to S108:

In Step S102, the motion blur information set by a user is obtained in response to receiving a motion blur request for a target video.

The motion blur information is used for indicating a blur processing manner, for example, indicating a specific mode and blur degree of performing motion blurring on the video frame in the target video. The embodiments of the present disclosure do not limit the specific contents contained in the motion blur information, and all the key information required in the motion blur processing may be set by the user. In some specific implementation examples, the motion blur information may include a motion blur mode and a blur degree, and further, may also include a fusion degree and the like. In practical application, the client interface may be provided with one or more setting items for setting the motion blur information for the user, so that the user may set the required information as required, for example, setting corresponding setting items for a motion blur mode, a blur degree and a fusion degree respectively, and the user may flexibly set the required motion blur information as required.

In some implementation examples, the motion blur mode includes a bidirectional mode and a unidirectional mode; wherein the unidirectional mode may be further divided into a leading mode and a trailing mode, and different motion blur modes correspond to different combinations of frame images to be processed. For example, for a same target frame image, the associated frame images of the target frame image selected for different motion blur modes are different and the effects produced are also different. For example, the client interface may be provided with three options including a bidirectional mode, a leading mode and a trailing mode for the user. For the bidirectional mode, the previous and next frame images of the target frame image are both associated frame images. For the leading mode, the previous frame image of the target frame image serves as an associated frame image. For the trailing mode, the next frame image of the target frame image serves as an associated frame image. Correspondingly, the effects produced by blurring the target frame image based on the associated frame image are different. The blur degree may be divided by numerical range, or divided by level. For example, the client interface may be provided with a blur interval of 0˜100 for the user, where the smaller the numerical value is, the lower the blur degree will be. For another example, a blur level of 0˜10 may be provided for the user, where the smaller the level is, the lower the blur degree will be. Similarly, the fusion degree may also be divided by the above-described manners, which will not be described in detail here. The above which is only illustrative, should not be regarded as being restrictive.

In S104, inter-frame motion estimation is performed on the target frame image in the target video and the associated frame image in the target frame image according to the motion blur information to obtain a motion trend between the target frame image and the associated frame image; wherein the target frame image is an image to be blurred.

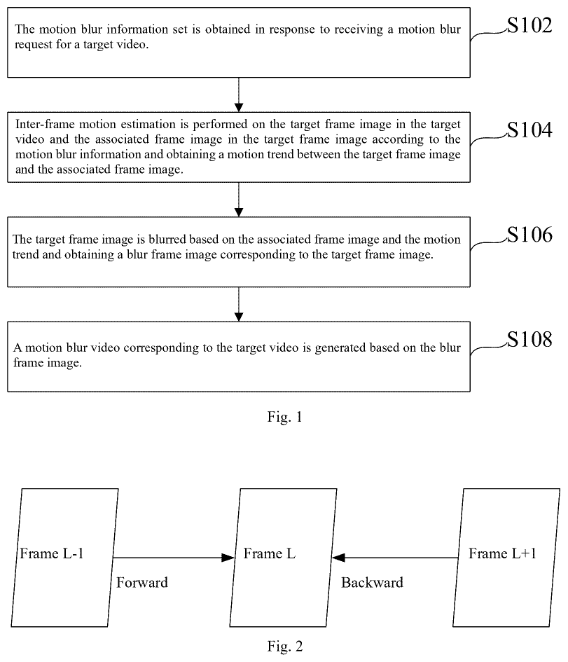

In practical application, the target frame image and the corresponding associated frame image mainly depend on the motion blur mode. In some embodiments, it is possible to first determine the target frame image in the target video and the corresponding associated frame image according to the motion blur mode, and then perform inter-frame motion estimation on the target frame image and the associated frame image, so as to evaluate a motion trend between the target frame image and the associated frame image. In some implementation examples, the motion trend may be representative of a motion vector (i.e., an optical flow). For convenient understanding, reference may be made to a schematic view of a motion blur direction shown in FIG. 2, which shows a previous frame (frame L−1), an intermediate frame (frame L) and a next frame (frame L+1). Taking the intermediate frame being the target frame image as an example, if motion blur processing is performed on the frame L based on the frame L−1, it will be a leading mode. If blur processing is performed on the frame L based on the frame L+1, it will be a trailing mode. If blur processing is performed on the frame L based simultaneously on the frame L−1 and the frame L+1, it will be a bidirectional mode. In practical application, it is possible to determine the selection direction of the associated frame image of the target frame image according to the motion blur mode set by the user, and estimate the motion trend of the target frame image and the associated frame image of the target frame image. In the case where the needs of the user are satisfied, an inter-frame motion estimation manner is also helpful to allow a subsequently obtained motion blur video to produce an authentic motion blur effect and enhance the inter-frame coherence.

In practical application, except for specific frames such as the first frame/last frame, which might not serve as target frame images due to the influence of the motion blur mode, other frame images may serve as target frame images to be blurred, and the motion blur modes are different and the associated frame images of the target frame image are also different.

In Step S106, blur processing is performed on the target frame image based on the associated frame image and the motion trend a blur frame image corresponding to the target frame image is obtained. In the case where the motion blur information includes a blur degree, it is possible to further perform blur processing on the target frame image based on the associated frame image, the motion trend and the blur degree and obtain the blur frame image corresponding to the target frame image. As the blur degrees are different, the blur effects of the blur frame image produced are also different.

In some embodiments, blur processing nay be performed on the target frame image based on a path interpolation method. For example, sampling is performed on the motion path of each pixel point between the associated frame image and the target frame image for multiple times to obtain a plurality of pixel sampling values, and then fusion processing is performed on the plurality of pixel sampling values corresponding to each pixel point and an original pixel value on the target frame image to obtain the blur frame image corresponding to the target frame image. Moreover, during the blur processing process, it is possible to adjust the blur effect of the blur frame image based on the blur degree.

In Step S108, a motion blur video corresponding to the target video is generated based on the blur frame image.

In some implementation examples, it is possible to directly sort the blur frame images corresponding to each target frame image obtained in a time sequence, so as to obtain the motion blur video corresponding to the target video. In other implementation examples, it is also possible to post-process the blur frame images and sort the post-processed blur frame images in a time sequence, so as to obtain the motion blur video corresponding to the target video. In addition, in practical application, other images in the target video that have not been blurred, such as the first frame/last frame, may not be processed but arranged with each blur frame image in sequence to generate a motion blur video. For example, the first frame image of the motion blur video is still the first frame image of the target video, and the other frame images of the motion blur video are the blur frame images corresponding to the other frame images in the target video.

The motion blur video obtained by using the above-described method may achieve a more authentic and coherent motion blur effect. Instead of performing motion blur processing by using fixed parameters, the target video is blurred based on the motion blur information set by the user, so that the user may personalize the motion blur information according to own needs. Different motion blur information may form a plurality of blur effects with abundant forms of expression, thereby making the finally obtained motion blur video more conform to the needs of the user.

Further, on the basis that the motion blur information includes a motion blur mode, the embodiments of the present disclosure provide a specific implementation of performing inter-frame motion estimation on the target frame image in the target video and the associated frame image of the target frame image according to the motion blur information, which may be realized by referring to the following Steps A to C:

In Step A, a frame image to be blurred in a target video is determined according to a motion blur mode, and the frame image to be blurred is taken as the target frame image. Specifically, it may be realized by referring to the following three conditions:

In the case where the motion blur mode is a bidirectional mode, other frame images in the target video than the first frame image and the last frame image are taken as the frame images to be blurred in the target video. In some embodiments, other frame images than the first frame image and the last frame image may be taken as the frame image to be blurred. In other embodiments, other designated frame images than the first frame image and the last frame image may also be taken as the frame image to be blurred, which may be specifically and flexibly set as required and is not limited here. It may be understood that, in the bidirectional mode, the frame image to be blurred needs to be blurred by way of the previous and next two frame images, so that other frame images than the first frame image and the last frame image may be selected as the target frame image. Also that is, the first frame image and last frame images in the target video cannot be bi-directionally blurred.

In the case where the motion blur mode is a leading mode, other frame images in the target video than the first frame image are taken as the frame images to be blurred in the target video. In some implementation examples, other frame images than the first frame image may be taken as the frame image to be blurred. In other implementation examples, other designated frame images than the first frame image may also be taken as the frame image to be blurred, which may be specifically and flexibly set as required and is not limited here. It may be understood that, in the case where the motion blur mode is a leading mode, the frame image to be blurred needs to be blurred by way of the previous frame image, so that other frame images than the first frame image may be selected as the target frame image. Also that is, the first frame image in the target video cannot be forwardly blurred.

In the case where the motion blur mode is a trailing mode, other frame images in the target video than the last frame image are taken as the frame images to be blurred in the target video. In some implementation examples, other frame images than the last frame image may be taken as the frame image to be blurred. In other implementation examples, other designated frame images than the last frame image may also be taken as the frame image to be blurred, which may be specifically and flexibly set as required and is not limited here. It may be understood that, in the case where the motion blur mode is a trailing mode, the frame image to be blurred needs to be blurred by way of the next frame image, so that other frame images than the last frame image may be selected as the target frame image. Also that is, the last frame image in the target video cannot be backwardly blurred.

The above-described manner of determining the target frame image to be blurred based on the motion blur mode is reasonable and also practical.

In Step B, the associated frame image of the target frame image in the target video is determined according to the motion blur mode. Specifically, it may also be realized by referring to the following three conditions:

In the case where the motion blur mode is a bidirectional mode, the previous frame image and the next frame image of the target frame image are taken as the associated frame images of the target frame image.

In the case where the motion blur mode is a leading mode, the previous frame image of the target frame image is taken as the associated frame image of the target frame image.

In the case where the motion blur mode is a trailing mode, the next frame image of the target frame image is taken as the associated frame image of the target frame image.

The above-described method of determining the associated frame image of the target frame image based on the motion blur mode is more reliable, and subsequently, the target frame image is blurred based on the associated frame image of the target frame image, thereby achieving a motion blur formed required by the user

In Step C, inter-frame motion estimation is performed on the target frame image and the associated frame image by using a preset optical flow algorithm.

The embodiment of the present disclosure does not limit the optical flow algorithm. For example, the preset optical flow algorithm may use a dense optical flow algorithm. Further, inter-frame motion estimation may be performed on the target frame image and the associated frame image based on the DIS optical flow algorithm. The DIS optical flow algorithm is the abbreviation of Dense Inverse Search-based method. Specifically, the DIS algorithm is to scale the image to different scales to construct an image pyramid, and then estimate the optical flow (i.e., a motion vector) layer by layer downwards from the lowest resolution layer. The optical flow estimated by each layer may serve as the initialization of the next layer of estimation, so as to achieve the purpose of accurately estimating the motion with different amplitudes. In practical application, inter-frame motion estimation may be performed on the target frame image and the associated frame image by directly using the original DIS optical flow algorithm, and inter-frame motion estimation may also be performed on the target frame image and the associated frame image by using an improved DIS optical flow algorithm after making an improvement on the basis of the original DIS optical flow algorithm. In the embodiment of the present disclosure, in order to reduce the calculation cost, a method of performing inter-frame motion estimation on the target frame image and the associated frame image based on an improved DIS optical flow algorithm is provided, which may be realized by referring to Steps C1 to C4:

In Step C1, down-sampling processing is performed on the target frame image and the associated frame image respectively. For example, the target frame image and the associated frame image may be both down-sampled to ½ resolution, and a method of reducing the image resolution is helpful to improve the image processing efficiency of a subsequent DIS optical flow algorithm and reduce the calculation cost of the algorithm.

In Step C2, inter-frame motion estimation is performed on the down-sampled target frame image and the down-sampled associated frame image based on an improved DIS optical flow algorithm so as to obtain a first motion vector; wherein the number of iterations used by the improved DIS optical flow algorithm is less than the number of iterations used by an original DIS optical flow algorithm. The embodiment of the present disclosure simplifies the DIS optical flow algorithm, which may reduce the number of iterations used by an original DIS optical flow algorithm when using gradient descent iterative optimization solution. For example, the applicant has found through studies that, the original DIS optical flow algorithm is changed from 12 iterations to 5 iterations, which may also favorably ensure the optical flow accuracy, and at the same time may also favorably reduce the calculation cost. It should be noted that, for a bidirectional mode, since the associated frame images of the target frame image are the previous and next frame images, it is necessary to perform motion estimation between the previous frame image and the target frame image and perform motion estimation between the target frame image and the next frame image respectively, and the obtained first motion vector includes a forward motion vector (a forward optical flow) and a backward motion vector (a backward optical flow). For the unidirectional mode (including the leading mode and the trailing mode), the first motion vector is either a forward motion vector or a backward motion vector, which will not be described in detail here.

In Step C3, up-sampling operation is performed on the first motion vector to obtain a second motion vector. The first motion vector is obtained by the simplified DIS optical flow algorithm, and the first motion vector is substantively the optical flow of the image after ½ down-sampling, which is equivalent to a sparse optical flow of every 2*2 pixels in the original image. In order to obtain the optical flow of each pixel, the second motion vector may be obtained by using a method of performing up-sampling on the first motion vector. Also that is, the dense optical flow of the original image may be obtained.

In Step C4, a motion vector between the target frame image and the associated frame image is obtained based on the second motion vector.

In some implementation examples, it is possible to perform mean value blur processing on the second motion vector, and take the second motion vector after mean value blur processing as the motion vector between the target frame image and the associated frame image. For example, mean value blurring may be performed on the second motion vector by using a kernel with a size of 9*9. In this way, it is possible to effectively remove the blocking artifact of the optical flow calculation and weaken the block edge, so as to reduce the block distortion phenomenon in subsequent interpolation and enhance the motion blur effect. Of course, in practical application, the second motion vector may also be directly taken as the motion vector between the target frame image and the associated frame image, and this method is more convenient and efficient. Specifically, the above-described method may be flexibly selected as required, and is not limited here.

To sum up, by performing the above-described Steps C1 to C4, it is possible to effectively ensure the prediction accuracy of the movement trend, with a low required calculation cost.

Further, the embodiment of the present disclosure may also provide the user with an option of a deformation blur function, also that is, a deformation blur effect may be incorporated into the motion blur processing process. Specifically, in some embodiments, the motion blur information also includes a state of a deformation blur function, which includes an enabled state or a disenabled state. Based on this, when blur processing is performed on the target frame image based on the associated frame image, the motion trend and the blur degree, the target frame image may be blurred based on the associated frame image, the motion trend and the blur degree according to a state of a deformation blur function. When the deformation blur function is in a disenabled state, blur processing may be performed on the target frame image only based on the associated frame image, the motion trend and the blur degree. When the deformation blur function is in an enabled state, the deformation blur effect may be incorporated into the motion blur processing process under the trigger of a specified condition. For example, the specified condition may be that the target frame image pertains to a transition frame image, or the target video is a video in the form of a slide. By way of the above-described method, it is helpful to incorporate the deformation blur effect in the motion blur processing process, especially for a transition video or a video in the form of a slide, and it is possible to allow the finally obtained motion blur effect to be more smooth and natural by incorporating the deformation blur effect.

In order to facilitate the understanding, the embodiment of the present disclosure provides a specific implementation of blurring the target frame image based on the associated frame image, the motion trend and the blur degree according to a state of a deformation blur function, which may be realized by referring to the following Steps 1 and 2a or Step 2b:

In Step 1, in the case where the state of a deformation blur function is enabled, it is judged whether the image contents between the target frame image and the associated frame image are related.

The embodiment of the present disclosure adequately considers that in the case where the image contents between two frames are not related (for example, a transition video or a video in the form of a slide), with a poor reliability of the motion vector obtained by directly estimating the motion of two frame images, it is likely to lead to excessive distortion of the blurred image. Therefore, it is possible to first discriminate the content relevance of the inter-frame images, and perform deformation blurring on the associated frame images in the case of no relevance, so as to perform inter-frame transition and enhance the inter-frame coherence.

Further, the embodiment of the present disclosure provides a specific implementation of judging whether the image contents between the target frame image and the associated frame image are related: the SAD value between the target frame image and the associated frame image may be obtained based on a preset SAD algorithm. Then, according to the SAD value and the preset threshold, it is judged whether the image contents between the target frame image and the associated frame image are related.

Wherein, the SAD (Sum of absolute differences) algorithm is a primary block matching algorithm in image stereo matching, and its basic operation idea is to find the sum of the absolute values of the differences between the pixel values in the corresponding left and right pixel blocks. The specific algorithm may be realized by referring to the related art, which will not be described in detail here. The embodiment of the present disclosure may effectively and objectively measure the content relevance between two frame images by using the SAD algorithm. In some embodiments, a preset threshold may be set directly. If the SAD value between two frame images is greater than the preset threshold, it will be considered that the target frame image is not related to the image content of the associated frame image, also that is, transition or slide image switching occurs. In other embodiments, discrimination may be made based on three frame images. For the previous frame (frame L−1), the intermediate frame (frame L) and the next frame (frame L+1), the first SAD value between the frame L−1 and the frame L and the second SAD value between the frame L and the frame L+1 may be calculated first, and the SAD difference between the first SAD value and the second SAD value may be then calculated. If the minimum of the first SAD value, the second SAD value and the SAD difference value is greater than the preset threshold, it will be considered that transition or slide switching occurs between the target frame image and the associated frame image, also that is, the image contents between the target frame image and the associated frame image are not related. By way of the above-described method, it is possible to reasonably and objectively discriminate the content relevance between two frame images, so as to obtain a more accurate discrimination result.

In Step 2a, if the image contents between the target frame image and the associated frame image are related, blur processing is performed on the target frame image based on the associated frame image, the motion trend and the blur degree.

Also that is, if the image contents between the target frame image and the associated frame image are related, blur processing will be directly performed according to the original frame image without using deformation blur, which is convenient and efficient and may achieve a favorable motion blur effect.

In Step 2b, if the image contents between the target frame image and the associated frame image are not related, deformation blur processing is performed on the associated frame image, and blur processing is performed on the target frame image based on the associated frame image subjected to deformation blur processing, the motion trend and the blur degree.

Since the estimation reliability of the motion trend between two frame images that are not related is generally very poor, and the motion vector obtained based on the estimation may also lead to excessive distortion of the image in the motion blur video, in order to improve this problem, deformation blur processing is performed on the associated frame image in the case where the image contents between the target frame image and the associated frame image are not related. For example, deformation blur processing may be performed on the associated frame image by using a random perspective transform method, and the specific deformation blur processing method is not limited here.

By way of the above-described method, it is possible to effectively reduce the distortion degree of the blur frame image, which allows a more authentic motion blur video.

In practical application, the motion trend is representative of a motion vector (also i.e., an optical flow). On this basis, the step of blurring the target frame image based on the associated frame image, the motion trend and the blur degree and obtaining the blur frame image corresponding to the target frame image is performed. In some embodiments, path interpolation may be performed based on the associated frame image, the motion trend and the blur degree, and blur processing is performed on the target frame image according to a path interpolation result (sampling is performed on the motion path for multiple times to obtain a plurality of pixel sampling values). Specifically, it may be realized by referring to the following Steps a to c.

In Step a, the motion vector between the target frame image and the associated frame image is adjusted based on the blur degree to obtain an adjusted motion vector.

In some implementation examples, it is possible to determine a scaling factor for adjusting the motion vector between the target frame image and the associated frame image according to the blur degree; and then multiply the scaling factor with the motion vector between the target frame image and the associated frame image to obtain an adjusted motion vector. Specifically, the blur degree may be used for changing the motion vector (or an optical flow value) obtained by the optical flow algorithm for motion estimation, and then performing subsequent blur processing by using the changed motion vector. For example, the blur degree is 0˜100, which may correspond to the scaling factor of 0˜1. If the user sets the blur degree to 0 (also i.e., the corresponding scaling factor is 0), the optical flow value obtained by motion estimation is 0, so that blur processing will not be performed. Also that is, the finally obtained motion blur video is substantively consistent with the original video. If the user sets the blur degree to 100 (also i.e., the corresponding scaling factor is 1), the motion vector obtained by motion estimation will not change. That is, blur processing is performed on the target frame image completely according to the motion vector calculated by the optical flow algorithm, so as to obtain the motion blur effect with a maximum blur degree. When the user sets the blur level between 0 and 100, the final motion blur effect will be weakened proportionally according to a specific value of the blur level.

In addition, the blur degree may be also set to 0˜300, for example. If the blur degree value selected by the user exceeds 100, the blur effect will be further exaggerated, which finally presents a distorted special effect. For example, the scaling factor corresponding to the blur degree value 200 is 2, and the scaling factor corresponding to the blur degree value 300 is 3, for example. Still according to the above-described method, the motion vector output by the optical flow algorithm is multiplied by the scaling factor (2, 3, etc.), and then processing such as path interpolation is performed based on the adjusted motion vector, so that it is possible to obtain an exaggerated distortion blur effect, and satisfy diversified editing needs of the user by providing a wide range of blur degree intervals for the user.

In Step b, the number of pixel point sampling times corresponding to the adjusted motion vector is obtained.

In the embodiment of the present disclosure, the number of pixel point sampling times may be obtained based on a length of the adjusted motion vector; wherein the length is positively correlated with the number of pixel point sampling times. This method may realize adaptive sampling and effectively save the calculation cost. In some embodiments, the number of pixel point sampling times may also be determined along the motion vector according to an equidistant sampling manner, and the interval distance between two sampling points may be set as required.

In the related art, regardless of a length of the motion vector, fixed sampling times are used. For the motion vector with a short length, it is likely to have redundant sampling and wasted computational power, that is, unnecessary sampling cost will be wasted. For the motion vector with a long length, it is likely to have insufficient sampling times, so that there may be apparent overlapping marks on the generated blur frame image. However, the adaptive method of obtaining the sampling times based on the length of the motion vector used in the embodiment of the present disclosure may more reasonably determine the sampling times and favorably ensure the reliability of the sampling results.

In Step c, blur processing is performed on the target frame image according to the pixel point sampling times and the adjusted motion vector to obtain a blur frame image corresponding to the target frame image. In some implementation examples, it may be realized by referring to the following steps c1 to c3:

In Step c1, for each pixel point on the target frame image, a plurality of pixel sampling values corresponding to the pixel point on the adjusted motion vector are obtained according to the number of pixel point sampling times. For example, equidistant sampling may be performed based on the number of pixel point sampling times to obtain a plurality of pixel sampling values.

In Step c2, cumulative average processing is performed on an original pixel value of each pixel point on the target frame image and a plurality of pixel sampling values corresponding to each pixel point to obtain a comprehensive pixel value corresponding to each pixel point.

In Step c3, a blur frame image corresponding to the target frame image is generated based on the comprehensive pixel value corresponding to each pixel point.

That is, by performing the above-described steps c1 to c3, cumulative average processing may be performed on each pixel on the motion path between two frame images according to an equidistant sampling manner, so that a smooth motion blur effect may be created.

To sum up, in the method of blurring the target frame image based on the adaptive sampling strategy provided by performing the above-described steps a to c, it is also possible to effectively reduce the operation cost while ensuring a natural and delicate obtained blur effect.

In order to further enrich the motion blur effect, the motion blur information also includes a fusion degree. The embodiment of the present disclosure may also provide a setting item of the fusion degree for the user, and the user may set the parameters of the fusion degree as required, so that it is also possible to obtain the fusion degree set by the user. When the motion blur video corresponding to the target video is generated based on the blur frame image, it is possible to fuse the blur frame image with the associated frame image based on the fusion degree to obtain the fusion frame image, and finally arrange a fusion frame image corresponding to each blur frame image in a time sequence so as to generate a motion blur video corresponding to the target video. The above-described method may also be referred to as post-fusion processing algorithm, and the above-described fusion degree is substantively a ghosting degree. By performing fusion on the blur frame image and the associated frame image, a ghosting effect may be achieved. Similarly, for example, the fusion degree may be set to 0-100, which corresponds to the fusion ratio of 0 to 1. If the fusion degree is 0, it represents that fusion is not performed on the blur frame image and the associated frame image, and the output fusion frame image is substantively still the blur frame image. When the fusion degree is 100, the ghosting effect of the output fusion frame image is the most intense. In practical application, the pixel points in two frame images may be weighted based on the fusion ratio corresponding to the fusion degree so as to obtain a fusion frame image, which may be realized by specifically referring to the related art, and will not be described in detail here. By way of the above-described method, it is also possible to present a ghosting effect in the motion blur effect provided for the user, so as to enrich the motion blur effect and satisfy the diversified needs of the user. If ghosting is not required for the user, the fusion degree will be directly set to 0.

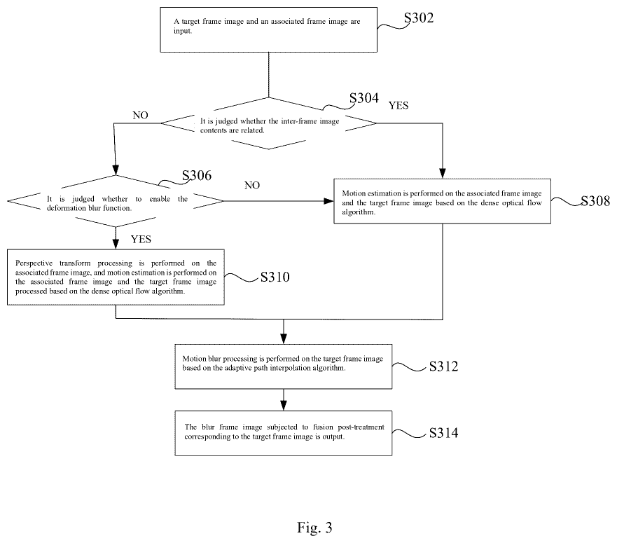

On the basis of the content described previously, the embodiment of the present disclosure also provides a flowchart of a motion blur method as shown in FIG. 3, which mainly includes the following steps S302 to S314:

In Step S302, a target frame image and an associated frame image are input.

In Step S304, it is judged whether the inter-frame image contents are related (i.e., it is discriminated whether the circumstances such as inter-frame transition/switching in the form of a slide occur). If YES, Step S306 is performed. If NO, Step S308 is performed.

In Step S306, it is judged whether to enable the deformation blur function. If YES, Step S310 is performed. If NO, Step S308 is performed.

In Step S308, motion estimation is performed on the associated frame image and the target frame image based on the dense optical flow algorithm, and then Step S312 is performed.

In Step S310, perspective transform processing is performed on the associated frame image, and motion estimation is performed on the associated frame image and the target frame image after processing based on the dense optical flow algorithm.

In Step S312, motion blur processing is performed on the target frame image based on the adaptive path interpolation algorithm.

In Step S314, the blur frame image corresponding to the target frame image is output.

For the specific implementation of the above-described steps, reference may be made to the aforementioned related content, which will not be described in detail here. The method of discriminating the inter-frame content relevance may effectively avoid the problems such as distortion resulting from performing motion blurring on the transition video or the video in the form of a slide. In the case where the content is irrelevant and the user enables the deformation blur function, it is possible to perform deformation blur processing such as perspective transform on the associated frame image so as to ensure a more smooth and natural motion blur effect as much as possible. Moreover, the method of blurring the target frame image by the adaptive path interpolation algorithm may also effectively reduce the operation cost while ensuring a natural and delicate obtained blur effect. To sum up, the obtained blur frame image is helpful to make the final motion blur video achieve a more authentic and coherent motion blur effect.

It should be noted that, each target frame image may use the above-described steps to obtain a blur frame image, and subsequently generate a motion blur video directly based on a combination of each blur frame image.

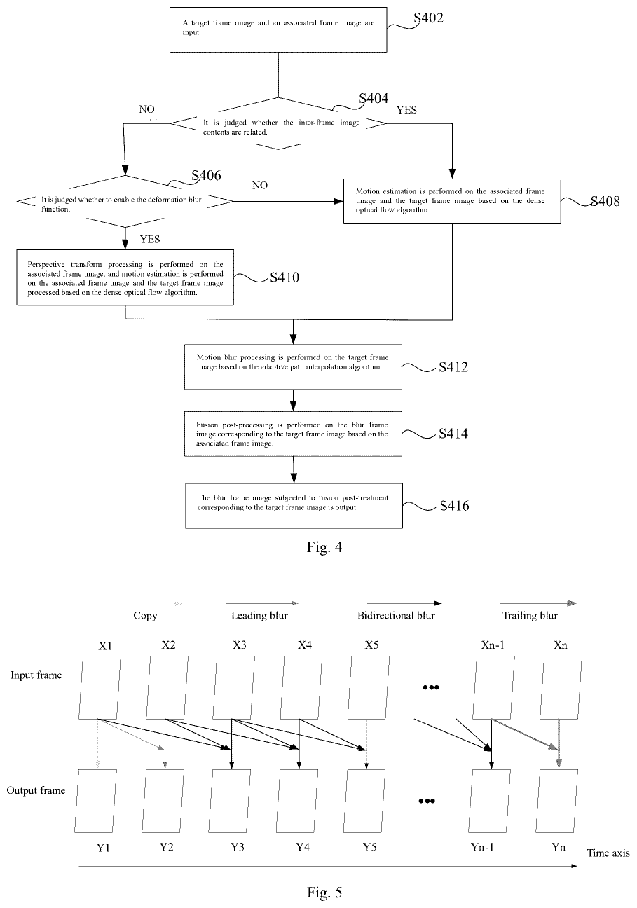

On the basis of FIG. 3, the embodiment of the present disclosure also provides a flowchart of a motion blur method as shown in FIG. 4, which mainly includes the following steps S402 to S416:

In Step S402, a target frame image and an associated frame image are input.

In Step S404, it is judged whether the inter-frame image contents are related (also i.e., it is discriminated whether the circumstances such as inter-frame transition/switching in the form of a slide occur). If YES, Step S406 is performed. If NO, Step S408 is performed;

In Step S406, it is judged whether to enable the deformation blur function. If YES, Step S410 is performed. If NO, Step S408 is performed.

In Step S408, motion estimation is performed on the associated frame image and the target frame image based on the dense optical flow algorithm, and then Step S412 is performed.

In Step S410, perspective transform processing is performed on the associated frame image, and motion estimation is performed on the associated frame image and the target frame image processed based on the dense optical flow algorithm.

In Step S412, motion blur processing is performed on the target frame image based on the adaptive path interpolation algorithm.

In Step S414, fusion post-processing is performed on the blur frame image corresponding to the target frame image based on the associated frame image.

In Step S416, the blur frame image subjected to fusion post-treatment corresponding to the target frame image is output.

The above-described Steps S402 to S412 are equivalent to the aforementioned Steps S302 to S312 in FIG. 3, and the related effects will not be described in detail here. FIG. 4 mainly lies in that fusion post-processing may be additionally performed on the blur frame image so as to enhance the ghosting effect, which further enriches the expression form of the motion blur effect and satisfy the diversified editing needs of the user.

In practical application, the embodiment of the present disclosure also provides a schematic view of input frames and output frames of a video as shown in FIG. 5, wherein the input frames are X1, X2, X3, X4, X5 . . . Xn-1, Xn; and the output frames are Y1, Y2, Y3, Y4, Y5 . . . Yn-1, Yn. In this example, the number of output frames is completely equal to the number of input frames. Also that is, the number of frames of the motion blur video is the same as the number of frames of the original target video.

In some embodiments, X1 corresponds to Y1, X2 corresponds to Y2 (for example, the blur frame image of X2 is Y2), X3 corresponds to Y3, and so forth. The embodiment is also a theoretical method, which may be applied in the scene where the required frame may be directly obtained. For example, it is possible to first obtain all the frames in the video, and then obtain a blur frame image by using the aforementioned motion blur processing method provided by the embodiment of the present disclosure for each frame image to be blurred, and thereinafter form a motion blur video by combination.

However, in practical application, considering that only the video frames can be obtained from the video one by one and processed and the next frames cannot be obtained in advance in some processing scenes, it may be realized by an offset method. For example, taking bidirectional motion blur as an example, for X2 as the target frame image, X1 and X3 are required as the associated frame images. For X3 as the target frame image, X2 and X4 are required as the associated frame images. However, when X2 is obtained, X3 cannot be directly obtained, so that leading blur may be performed on X2 only based on X1 to obtain Y2. When X3 is obtained, X4 cannot be directly obtained. At present, there are only X1 to X3. At this time, X2 may be bidirectionally blurred based on X1 and X3, so as to obtain a blur frame image X2′ corresponding to X2. At this time, X2′ may be offset as the third frame Y3 of the motion blur video, and so forth until Xn is obtained. Trailing blur may be performed on Xn-1 based on Xn, Xn-1′ may be regarded as Yn. In addition, FIG. 5 illustrates that Y1 may be obtained by copying X1 directly without processing the same. FIG. 5 is an example of the above-described offset method, but it should not be regarded as being restrictive. For example, for the last frame Yn, Xn-1 may also be bidirectionally blurred based on Xn-2 and Xn, and the obtained Xn-1′ may be regarded as Yn. Alternatively, it is also possible to only copy Xn and regard the copied Xn as Yn. The above are all exemplary descriptions. For the first frame/last frame, a corresponding processing method may be flexibly selected as required and is not limited here.

To sum up, compared with the related art described previously, in the video processing method provided by the embodiment of the present disclosure, instead of performing motion blur processing by using fixed parameters, blur processing is performed on the target video based on the motion blur information set by a user, and different motion blur modes and different blur degrees may form a plurality of blur effects with abundant forms of expression. Moreover, it is possible to further provide a deformation blur function setting item and a fusion degree setting item for the user, and provide a deformation blur effect and a ghost effect according to the inter-frame content relevance, which not only enriches the obtained motion blur effect, but also is suitable for special videos such as a transition video and a video in the form of a slide, with a wider application range. In addition, when blur processing is performed on the target frame image, it is possible to ensure a favorable motion blur effect to a certain extent while also effectively reducing the operation cost based on the adaptive path interpolation algorithm and the simplified optical flow algorithm, which is convenient for real-time rendering and suitable for a computer or a mobile terminal. To sum up, the obtained motion blur video may achieve a more authentic and coherent motion blur effect, and more conform to the diversified needs of the user.

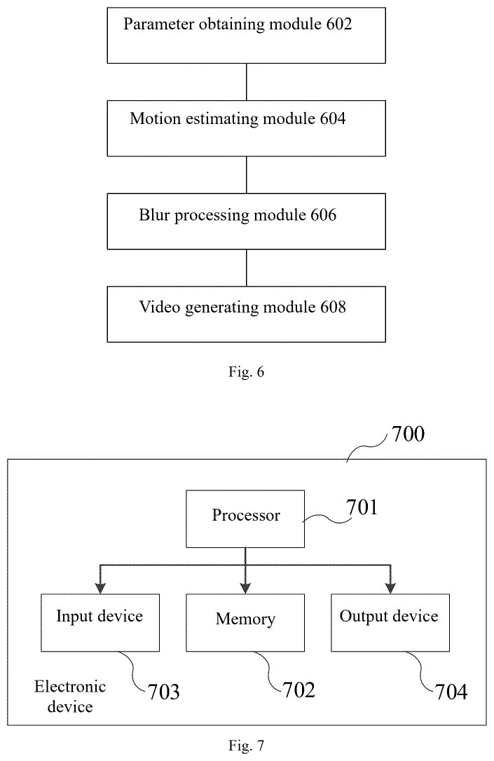

Corresponding to the aforementioned video processing method, the embodiment of the present disclosure also provides a video processing apparatus. FIG. 6 is a schematic structural view of a video processing apparatus provided by the embodiment of the present disclosure. The device may be realized by software and/or hardware, and may generally be integrated into the electronic device, as shown in FIG. 6, and includes:

A parameter obtaining module 602 configured to obtain the motion blur information set by a user in response to receiving a motion blur request for a target video; wherein the motion blur information indicates a blur processing manner;

A motion estimating module 604 configured to perform inter-frame motion estimation on a target frame image in the target video and an associated frame image of the target frame image in the target video according to motion blur information to obtain a motion trend between the target frame image and the associated frame image; wherein the target frame image is an image to be blurred;

A blur processing module 606 configured to perform blur processing on the target frame image based on the associated frame image and the motion trend and to obtain a blur frame image corresponding to the target frame image; and

A video generating module 608 configured to generate a motion blur video corresponding to the target video based on the blur frame image.

The motion blur video obtained by the above-described device may achieve a more authentic and coherent motion blur effect, and instead of performing motion blur processing by using fixed parameters, blur processing is performed on the target video based on the motion blur information set by a user, so that the user may personalize the motion blur information according to own needs. Different motion blur information may form a plurality of blur effects with abundant forms of expression, thereby making the finally obtained motion blur video more conform to the needs of the user.

In some embodiments, the motion blur information includes a motion blur mode, and the motion estimating module 604 is specifically configured to: determine a frame image to be blurred in the target video according to the motion blur mode, and take the frame image to be blurred as the target frame image; determine an associated frame image of the target frame image in the target video according to the motion blur mode; and perform inter-frame motion estimation on the target frame image and the associated frame image by using a preset optical flow algorithm.

In some embodiments, the motion estimating module 604 is specifically configured to: take other frame images in the target video than the first frame image and the last frame image as frame images to be blurred in the target video in the case where the motion blur mode is a bidirectional mode; take other frame images in the target video than the first frame image as frame images to be blurred in the target video in the case where the motion blur mode is a leading mode; and take other frame images in the target video than the last frame image as frame images to be blurred in the target video in the case where the motion blur mode is a trailing mode.

In some embodiments, the motion estimating module 604 is specifically configured to: take a previous frame image and a next frame image of the target frame image as associated frame images of the target frame image in the case where the motion blur mode is a bidirectional mode; take the previous frame image of the target frame image as an associated frame image of the target frame image in the case where the motion blur mode is a leading mode; and take the next frame image of the target frame image as an associated frame image of the target frame image in the case where the motion blur mode is a trailing mode.

In some embodiments, the motion estimating module 604 is specifically configured to: perform down-sampling processing on the target frame image and the associated frame image respectively; perform inter-frame motion estimation on the down-sampled target frame image and the down-sampled associated frame image based on an improved DIS optical flow algorithm so as to obtain a first motion vector; wherein the number of iterations used by the improved DIS optical flow algorithm is less than the number of iterations used by an original DIS optical flow algorithm; perform up-sampling operation on the first motion vector to obtain a second motion vector; and obtain a motion vector between the target frame image and the associated frame image based on the second motion vector.

In some embodiments, the motion estimating module 604 is specifically configured to: perform mean value blur processing on the second motion vector, and take the second motion vector after mean value blur processing as a motion vector between the target frame image and the associated frame image.

In some embodiments, the motion blur information includes a blur degree; the blur processing module 606 is specifically configured to: perform blur processing on the target frame image based on the associated frame image, the motion trend and the blur degree.

In some embodiments, the motion blur information also includes a state of a deformation blur function; the state includes an enabled state or a disenabled state; the blur processing module 606 is specifically configured to: perform blur processing on the target frame image based on the associated frame image, the motion trend and the blur degree according to the state of a deformation blur function.

In some embodiments, the blur processing module 606 is specifically configured to: judge whether the image contents between the target frame image and the associated frame image are related in the case where the state of a deformation blur function is enabled; perform blur processing on the target frame image based on the associated frame image, the motion trend and the blur degree if the image contents between the target frame image and the associated frame image are related; and perform deformation blur processing on the associated frame image, and perform blur processing on the target frame image based on the associated frame image subjected to deformation blur processing, the motion trend and the blur degree if the image contents between the target frame image and the associated frame image are not related.

In some embodiments, the blur processing module 606 is specifically configured to: obtain a SAD value between the target frame image and the associated frame image based on a preset SAD algorithm; and judge whether the image contents between the target frame image and the associated frame image are related according to the SAD value and a preset threshold.

In some embodiments, the motion trend is represented in the form of a motion vector; the blur processing module 606 is specifically configured to: adjust a motion vector between the target frame image and the associated frame image based on the blur degree so as to obtain an adjusted motion vector; obtain the number of pixel point sampling times corresponding to the adjusted motion vector; and perform blur processing on the target frame image according to the number of pixel point sampling times and the adjusted motion vector, and obtain a blur frame image corresponding to the target frame image.

In some embodiments, the blur processing module 606 is specifically configured to: determine a scaling factor for adjusting the motion vector between the target frame image and the associated frame image according to the blur degree; and multiply the scaling factor with the motion vector between the target frame image and the associated frame image to obtain an adjusted motion vector.

In some embodiments, the blur processing module 606 is specifically configured to: obtain the number of pixel point sampling times based on a length of the adjusted motion vector; wherein the length is positively correlated with the number of pixel point sampling times.

In some embodiments, the blur processing module 606 is specifically configured to: for each pixel point on the target frame image, obtain a plurality of pixel sampling values corresponding to the pixel point on the adjusted motion vector according to the number of pixel point sampling times; perform cumulative average processing on an original pixel value of each pixel point on the target frame image and a plurality of pixel sampling values corresponding to each pixel point to obtain a comprehensive pixel value corresponding to each pixel point; and generate a blur frame image corresponding to the target frame image based on the comprehensive pixel value corresponding to each pixel point.

In some embodiments, the motion blur information also includes a fusion degree. On this basis, the video generating module 608 is specifically configured to: fuse the blur frame image and the associated frame image based on the fusion degree to obtain a fusion frame image; and arrange the fusion frame image corresponding to the each blur frame image in a time sequence to generate a motion blur video corresponding to the target video.

The video processing apparatus provided by the embodiment of the present disclosure may perform the video processing method provided by any embodiment of the present disclosure, and possesses corresponding functional modules and beneficial effects to perform the method.

It may be clearly understood by those skilled in the art that for convenient and concise description, for the specific operation process of the device embodiment described above, reference may be made to the corresponding process in the method embodiment, which will not be described in detail here.

FIG. 7 is a schematic structural view of an electronic device provided by embodiments of the present disclosure. As shown in FIG. 7, the electronic device 700 includes one or more processors 701 and a memory 702.

The processor 701 may be a central processing unit (CPU) or other forms of processing unit with data processing capability and/or instruction execution capability, and may control other assemblies in the electronic device 700 to perform a desired function.

The memory 702 may include one or more computer program products, which may include various forms of computer-readable storage media, for example, volatile memory and/or nonvolatile memory. The volatile memory may include, for example, a random access memory (RAM) and/or a cache and the like. The nonvolatile memory may include, for example, a read-only memory (ROM), a hard disk, a flash memory and the like. The computer-readable storage medium may store one or more computer program instructions, which may be executed by the processor 701 to implement the video processing method and/or other desired functions of the embodiments of the present disclosure described above. The computer-readable storage medium may also store various contents such as input signals, signal components, noise components and the like.

In one example, the electronic device 700 may further include: an input device 703 and an output device 704, which are interconnected through a bus system and/or other forms of connection mechanisms (not shown).

In addition, the input device 703 may also include, for example, a keyboard, a mouse and the like.

The output device 704 may output various information to the outside, which includes the determined distance information and direction information and the like. The output device 704 may include, for example, a display, a speaker, a printer, a communication network and a remote output device connected thereto and the like.

Of course, for simplicity, FIG. 7 only shows some assemblies related to the present disclosure in the electronic device 700, and assemblies such as a bus and an I/O interface are omitted. Besides, according to specific application conditions, the electronic device 700 may also include any other suitable assembly.

In addition to the above-described methods and devices, the embodiment of the present disclosure may also be computer program products, which include computer program instructions that, when executed by a processor, cause the processor to perform the video processing method provided by the embodiments of the present disclosure.

The computer program products may write computer program codes for performing the operations of the present disclosure in any combination of one or more programming languages. The programming languages include object-oriented programming languages, such as Java and C++, and also include conventional procedural programming languages, such as “C” language or similar programming languages. The program codes may be executed entirely on the user's computing device, executed partly on the user's computing device, executed as an independent software package, executed partly on the user's computing device, executed partly on a remote computing device, or executed entirely on the remote computing device or server.

In addition, the embodiment of the present disclosure may also be a non-transitory computer-readable storage medium having computer program instructions stored thereon that, when executed by a processor, cause the processor to perform the video processing method provided by the embodiments of the present disclosure.

The computer-readable storage medium may use any combination of one or more readable media. The readable medium may be a readable signal medium or a readable storage medium. The readable storage medium may, for example, includes but is not limited to: an electrical, magnetic, optical, electromagnetic, infrared, or semiconductor system, device or apparatus, or any combination thereof. More specific examples (a non-exhaustive list) of the readable storage medium include: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The embodiment of the present disclosure also provides a computer program product including a computer program/instruction that, when executed by a processor implements the video processing method in the embodiment of the present disclosure.

The embodiment of the present disclosure also provides a computer program that, when executed by a processor implements the video processing method in the embodiment of the present disclosure.

It is to be noted that, the relational terms such as “first” and “second” herein are only used to distinguish one entity or operation from another entity or operation, but do not necessarily require or imply any such actual relationship or sequence present between these entities or operations. Moreover, the terms “comprising”, “including” or any other variation thereof are intended to cover non-exclusive inclusions, so that a process, method, article or device including a series of elements includes not only those elements, but also other elements not explicitly listed or elements inherent to such process, method, article or device. In the case where there are no more restrictions, an element defined by the phrase “including one . . . ” does not exclude an additional identical element also present in the process, method, article or device including the element.

The above content only pertains to a detailed description of the present disclosure, so that those skilled in the art may understand or realize the present disclosure. Multiple modifications to these embodiments will be obvious for those skilled in the art, and the general principles defined herein may be realized in other embodiments without departing from the spirit or scope of this disclosure. Therefore, the present disclosure will not be limited to these embodiments described herein, but intended to conform to the broadest scope consistent with the principles and novel features disclosed herein.

1. A video processing method, comprising:
in response to receiving a motion blur request for a target video, obtaining motion blur information set; wherein the motion blur information indicates a blur processing manner;
performing inter-frame motion estimation on a target frame image in the target video and an associated frame image of the target frame image according to the motion blur information and obtaining a motion trend between the target frame image and the associated frame image; wherein the target frame image is an image to be blurred;
performing blur processing on the target frame image based on the associated frame image and the motion trend and obtaining a blur frame image corresponding to the target frame image; and
generating a motion blur video corresponding to the target video based on the blur frame image.

2. The method according to claim 1, wherein the motion blur information comprises a motion blur mode, and the step of performing inter-frame motion estimation on a target frame image in the target video and an associated frame image of the target frame image according to the motion blur information comprises:
determining a frame image to be blurred in the target video according to the motion blur mode, and taking the frame image to be blurred as a target frame image;
determining an associated frame image of the target frame image in the target video according to the motion blur mode; and
performing inter-frame motion estimation on the target frame image and the associated frame image by using a preset optical flow algorithm.

3. The method according to claim 2, wherein the step of determining a frame image to be blurred in the target video according to the motion blur mode comprises:
taking other frame images in the target video than a first frame image and a last frame image as frame images to be blurred in the target video in the case where the motion blur mode is a bidirectional mode;
taking other frame images in the target video than the first frame image as frame images to be blurred in the target video in the case where the motion blur mode is a leading mode; and
taking other frame images in the target video than the last frame image as frame images to be blurred in the target video in the case where the motion blur mode is a trailing mode.

4. The method according to claim 2, wherein the step of determining an associated frame image of the target frame image in the target video according to the motion blur mode comprises:
taking a previous frame image and a next frame image of the target frame image as associated frame images of the target frame image in the case where the motion blur mode is a bidirectional mode;
taking the previous frame image of the target frame image as an associated frame image of the target frame image in the case where the motion blur mode is a leading mode; and
taking the next frame image of the target frame image as an associated frame image of the target frame image in the case where the motion blur mode is a trailing mode.

5. The method according to claim 2, wherein the step of performing inter-frame motion estimation on the target frame image and the associated frame image by using a preset optical flow algorithm comprises:
performing down-sampling processing on the target frame image and the associated frame image respectively;
performing inter-frame motion estimation on the down-sampled target frame image and the down-sampled associated frame image based on an improved DIS optical flow algorithm so as to obtain a first motion vector; wherein the number of iterations used by the improved DIS optical flow algorithm is less than the number of iterations used by an original DIS optical flow algorithm;
performing up-sampling operation on the first motion vector to obtain a second motion vector; and
obtaining a motion vector between the target frame image and the associated frame image based on the second motion vector.

6. The method according to claim 5, wherein the step of obtaining a motion vector between the target frame image and the associated frame image based on the second motion vector comprises:
performing mean value blur processing on the second motion vector, and taking the second motion vector after mean value blur processing as the motion vector between the target frame image and the associated frame image.

7. The method according to claim 1, wherein the motion blur information comprises a blur degree;
the step of performing blur processing on the target frame image based on the associated frame image and the motion trend comprises:
performing blur processing on the target frame image based on the associated frame image, the motion trend and the blur degree.

8. The method according to claim 7, wherein the motion blur information further comprises a state of a deformation blur function; the state comprises an enabled state or a disenabled state;
the step of performing blur processing on the target frame image based on the associated frame image, the motion trend and the blur degree comprises:
performing blur processing on the target frame image based on the associated frame image, the motion trend and the blur degree according to a state of the deformation blur function.

9. The method according to claim 8, wherein the step of performing blur processing on the target frame image based on the associated frame image, the motion trend and the blur degree according to a state of the deformation blur function comprises:
judging whether image contents between the target frame image and the associated frame image are related in the case where a state of a deformation blur function is the enabled state;
in response that the image contents between the target frame image and the associated frame image are related, performing blur processing on the target frame image based on the associated frame image, the motion trend and the blur degree; and
in response that the image contents between the target frame image and the associated frame image are not related, performing deformation blur processing on the associated frame image, and performing blur processing on the target frame image based on the associated frame image after deformation blur processing, the motion trend and the blur degree.

10. The method according to claim 9, wherein the step of judging whether image contents between the target frame image and the associated frame image are related comprises:
obtaining a SAD value between the target frame image and the associated frame image based on a preset SAD algorithm; and
judging whether the image contents between the target frame image and the associated frame image are related according to the SAD value and a preset threshold.

11. The method according to claim 7, wherein the motion trend is represented in the form of a motion vector; the step of performing blur processing on the target frame image based on the associated frame image, the motion trend and the blur degree and obtaining a blur frame image corresponding to the target frame image comprises:
adjusting a motion vector between the target frame image and the associated frame image based on the blur degree so as to obtain an adjusted motion vector;
obtaining a number of pixel point sampling times corresponding to the adjusted motion vector; and
performing blur processing on the target frame image according to the number of pixel point sampling times and the adjusted motion vector and obtaining a blur frame image corresponding to the target frame image.

12. The method according to claim 11, wherein the step of adjusting a motion vector between the target frame image and the associated frame image based on the blur degree so as to obtain an adjusted motion vector comprises:
determining a scaling factor for adjusting the motion vector between the target frame image and the associated frame image according to the blur degree; and
multiplying the scaling factor with the motion vector between the target frame image and the associated frame image to obtain the adjusted motion vector.

13. The method according to claim 11, wherein the step of obtaining a number of pixel point sampling times corresponding to the adjusted motion vector comprises:
obtaining the number of pixel point sampling times based on a length of the adjusted motion vector; wherein the length is positively correlated with the number of pixel point sampling times.

14. The method according to claim 11, wherein the step of performing blur processing on the target frame image according to the number of pixel point sampling times and the adjusted motion vector to obtain a blur frame image corresponding to the target frame image comprises:
for each pixel point on the target frame image, obtaining a plurality of pixel sampling values corresponding to the pixel point on the adjusted motion vector according to the number of pixel point sampling times;
performing cumulative average processing on an original pixel value of each pixel point on the target frame image and a plurality of pixel sampling values corresponding to each pixel point to obtain a comprehensive pixel value corresponding to each pixel point; and
generating a blur frame image corresponding to the target frame image based on the comprehensive pixel value corresponding to each pixel point.

15. The method according to claim 1, wherein the motion blur information further comprises a fusion degree;
the step of generating a motion blur video corresponding to the target video based on the blur frame image comprises:
fusing the blur frame image and the associated frame image based on the fusion degree to obtain a fusion frame image; and
arranging the fusion frame image corresponding to each blur frame image in a time sequence to generate the motion blur video corresponding to the target video.

16. (canceled)

17. An electronic device, comprising:
a processor;
a memory for storing executable instructions by the processor; and
the processor is configured to read the executable instructions from the memory and execute the executable instructions to implement a video processing method, comprising:
in response to receiving a motion blur request for a target video, obtaining motion blur information set; wherein the motion blur information indicates a blur processing manner;
performing inter-frame motion estimation on a target frame image in the target video and an associated frame image of the target frame image according to the motion blur information and obtaining a motion trend between the target frame image and the associated frame image; wherein the target frame image is an image to be blurred;
performing blur processing on the target frame image based on the associated frame image and the motion trend and obtaining a blur frame image corresponding to the target frame image; and
generating a motion blur video corresponding to the target video based on the blur frame image.

18. A non-transitory computer-readable storage medium having a computer program stored thereon for performing a video processing method, comprising:
in response to receiving a motion blur request for a target video, obtaining motion blur information set; wherein the motion blur information indicates a blur processing manner;
performing inter-frame motion estimation on a target frame image in the target video and an associated frame image of the target frame image according to the motion blur information and obtaining a motion trend between the target frame image and the associated frame image; wherein the target frame image is an image to be blurred;
performing blur processing on the target frame image based on the associated frame image and the motion trend and obtaining a blur frame image corresponding to the target frame image; and
generating a motion blur video corresponding to the target video based on the blur frame image.

19. (canceled)

20. The electronic device according to claim 17, wherein the motion blur information comprises a motion blur mode, and the step of performing inter-frame motion estimation on a target frame image in the target video and an associated frame image of the target frame image according to the motion blur information comprises:
determining a frame image to be blurred in the target video according to the motion blur mode, and taking the frame image to be blurred as a target frame image;
determining an associated frame image of the target frame image in the target video according to the motion blur mode; and
performing inter-frame motion estimation on the target frame image and the associated frame image by using a preset optical flow algorithm.

21. The electronic device according to claim 20, wherein the step of determining a frame image to be blurred in the target video according to the motion blur mode comprises:
taking other frame images in the target video than a first frame image and a last frame image as frame images to be blurred in the target video in the case where the motion blur mode is a bidirectional mode;
taking other frame images in the target video than the first frame image as frame images to be blurred in the target video in the case where the motion blur mode is a leading mode; and
taking other frame images in the target video than the last frame image as frame images to be blurred in the target video in the case where the motion blur mode is a trailing mode.

22. The electronic device according to claim 20, wherein the step of determining an associated frame image of the target frame image in the target video according to the motion blur mode comprises:
taking a previous frame image and a next frame image of the target frame image as associated frame images of the target frame image in the case where the motion blur mode is a bidirectional mode;
taking the previous frame image of the target frame image as an associated frame image of the target frame image in the case where the motion blur mode is a leading mode; and
taking the next frame image of the target frame image as an associated frame image of the target frame image in the case where the motion blur mode is a trailing mode.
